(19) United States
(12) Patent Application Publication
(10) Pub. No.: US 2015/0250031 A1
(43) Pub. Date: Sep. 3, 2015

(54) METHOD AND DEVICES FOR FOOD-FRIENDLY MICROWAVE COOKING

(71) Applicant: Julio, Antonio GOMEZ, Sunnybank,QLD (AU)

(72) Inventor: Julio Antonio Gomez, Sunnybank (AU)

(21) Appl. No.: 14/438,557

(22) PCT Filed: Oct. 23, 2013
(86) PCT No.: PCT/AU2013/001232

§ 371 Date: Apr. 24, 2015

(30) Foreign Application Priority Data
Oct. 27, 2012 (AU) 2012904638

(51) Int. Cl. H05B 6/80

(52) U.S. Cl. CPC H05B 6/80; H05B 2206/044

(57) ABSTRACT

A method of heating or cooking an item of food comprising placing the item to absorb microwave energy on a titled surface in a microwave oven, before dispersing the microwave energy to start the heating process.

### FIELD OF INVENTION

The present invention relates to the devices and method for healthy food cooking and heating in microwave ovens using under 50% of the microwave energy.

### BACKGROUND

Cooking by conventional means, for example by the oven, usually is time consuming. For example, a meat pie takes about 30 minutes to cook in a conventional oven. Also pastries become soggy in microwave ovens so the present inventor's first invention related to the microwave ovens WO94/16606 (“NOTSOSOGGY™”) overcomes this sogginess problem and subsequently won a Silver Medal in Geneva 1996. The second invention, WO2005/032318 (“Warming Tray™”) fine-tuned, simplified and expanded the usage of the original device with novel devices.

The additional problem of microwave ovens relates to “OVERHEATING”. To cook/reheat food in microwave ovens and preserve food integrity consistently the temperature must be raised gradually until the foods internal temperature reaches 75° C. as the maximum temperature.

Overheating is common to all microwave ovens, and becomes extreme as the power increases and is responsible for production of highly detrimental food with little or no nutritional value which may harm us internally in the long run. Overheated food is tasteless, chewy, hard as rock, and makes black spots in meat and sauces.

The first two inventions introduced devices to control sogginess by lifting pastries, pizzas, schnitzel or any solid food by allowing dry air to flow underneath, keeping the bottom nicely dry, thereby providing a simple and elegant solution. Once sogginess was beaten a huge hidden problem of microwave ovens remains, overheating.

The real challenge is to control overheating and determine how to preserve food's original quality and goodness. The solution requires a thorough understanding of food composition, microwave energy, infrared energy, current cooking appliances, current cooking methods and the analysis of cooking as an energy transfer event.

### SUMMARY OF INVENTION

The present invention provides a method of heating or cooking an item of food comprising placing the item to absorb microwave energy before dispersing on a titled surface during the heating process in a microwave oven.

Preferably, the angle of tilt is large enough to allow pastries or solid food full exposure to microwave energy and low enough to keep liquids safely inside the heating or cooking container.

Preferably, a support means lifts and tilts the item of food to face the Microwave Output and heats up the food gently like in conventional ovens by exposing foods completely to a FIRST WAVE setting emulating conventional ovens.

In another aspect, the present invention provides a method of heating an item of food in current microwave ovens emulating conventional means comprising:
low Setting as default;
aligning and tilting the turning table to microwave flux outlet with adjustable means and a fixed heat resistant warming tray;
disturbing liquids surface tension with small imperfections to turning table support wheels
reducing magnetron output below 500 watts.

Preferably, a support means lifts and tilts the item of food to face more than one magnetron under 500 watts to heat up the food gently like in conventional ovens by exposing foods completely to a FIRST WAVE setting emulating conventional ovens improving current microwave ovens as follows:
Minimising microwave overheating
Maintaining or increasing cooking speed within healthy parameters
Exposing food to a single low power magnetron
The heat source resembling the heating environment of conventional ovens
Synchronising magnetrons output to minimise hot spot or overheating spots
Separating beam to minimise hot spot or overheating spots; and
Bouncing microwaves likely to produce hot spot or spot overheating are absorbed by a semi conductive wall releasing infrared heat as conventional ovens.

Preferably, a warming tray comprises two brackets designed to be fitted to the back of the tray thereby providing a tilted configuration.

Preferably, the method heats or cooks Frozen Food items packed in hard containers wherein the lifting and tilting is achieved by means of a folded insert device which is open and placed and heated on top of the packaging, satisfying the First Wave method.

Preferably, the insert may be designed tilted such that a lid may remain closed and become more stable.

Preferably, the insert may be designed tilted and high enough to satisfy First Wave Method.

Preferably, packaging may be designed with an incorporated warming tray, tilted and high enough to satisfy First Wave Method.

Preferably, the use of the technology results in reducing carbon emission.

In another aspect, the present invention provides an article for use in a microwave oven comprising a support means' for heating or cooking of an item of food wherein the support means is tilted by adjustable means for item of food solid, liquid or a mixture of both.

Preferably, the article further comprises a folded insert device which is open and placed and heated on top of the packaging, satisfying the First Wave method.

Preferably, the insert may be designed tilted such that a lid may remain closed and be more stable.

Preferably, the insert may be designed tilted and high enough to satisfy First Wave Method.

Preferably, packaging may be designed with an incorporated warming tray, tilted and high enough to satisfy First Wave Method.

Preferably, a warming tray comprises two brackets designed to be fitted to the back of the tray thereby providing a tilted configuration.

Preferably, the article further comprises small imperfections to turning table support wheels.

Preferably, the adjustable means comprises an extendable frame.

Preferably, the item of food is a form of pastry, stew or soup and the like.

### BRIEF DESCRIPTION OF DRAWINGS

FIG. 1 illustrates the conventional means of cooking or heating

FIG. 2 illustrates the energy flow generated by a Magnetron during microwave cooking

FIGS. 3A and 3B illustrate the electromagnetic forces in use

FIG. 4 illustrates the changes in electromagnetic field in a radio receiver

FIG. 5 illustrates the warming tray as an embodiment of the invention

FIG. 6 illustrates the Packing Heating device as an embodiment of the invention

FIG. 7 illustrates the heating insert as an embodiment of the invention

FIGS. 8A and 8B illustrate the micro frame as an embodiment of the invention

FIG. 9 illustrates the bracket as an embodiment of the invention

FIG. 10 illustrates the bracket in use as an embodiment of the invention

FIG. 11 illustrates the bracket in Cross configuration as an embodiment of the invention

FIG. 12 illustrates the titled Micro Frame, as an embodiment of the present invention

FIG. 13 illustrates the various features in sequence, as an embodiment of the present invention

FIG. 14 illustrates the insert when used as a lifting means as an embodiment of the invention

FIG. 15 illustrates the use of combination of the Warming Tray and the Micro Frame

FIG. 16 illustrates the basic multi-magnetron Microwave Oven

### DETAILED DESCRIPTION OF THE INVENTION

The present invention relates to the devices and method for healthy food cooking and heating in microwave ovens using under 50% of the microwave energy. This is achieved by aligning the food to the microwave oven “Microwaves Output” at “Low Power”, basically exposing food to the “First Wave” at “Low Power” which is similar to the infrared energy absorbed by foods within conventional means. This novel method preserve food's original or intended quality, texture, original nutritional value and good taste. Therefore this innovation allows cooking with microwave as good as conventional means, but healthier and cheaper.

The term “First Wave” relates to the amount of energy supplied by the microwave source to the item to be heated or cooked at the very first instance of the heating process. This energy is predominantly used to heat or cook food in a gentle manner as in a conventional oven. Hence, food is not subject of overheating.

The present inventor introduces new findings based on scientific facts, leading to a novel method in how to use current microwave ovens to preserve consistently foods original texture and goodness, open the door to healthy cooking/heating of frozen food in microwave ovens, redesign current microwave ovens novel food-friendly microwave ovens, and introduce a new generation of industrial, domestic microwave ovens capable to cook, steam, bake and brown faster and efficient than conventional means using under 95% of energy and under 50% of current microwave ovens energy.

### Our Food

Food in general is fragile; mainly we consume living tissues which are made of flimsy structures (fibres) saturated with delicate nutrients, vitamins, mineral traces and volatile compounds which can be easily destroyed if the heat raises too fast or over the healthy limit. The Australian Statutory Authority recommends the maximum safe cooking temperature of 75° C. at the food's core; the temperature must be risen gradually to avoid losing nutritional value by a sudden heat and/or overheating.

### Conventional Cooking Basic

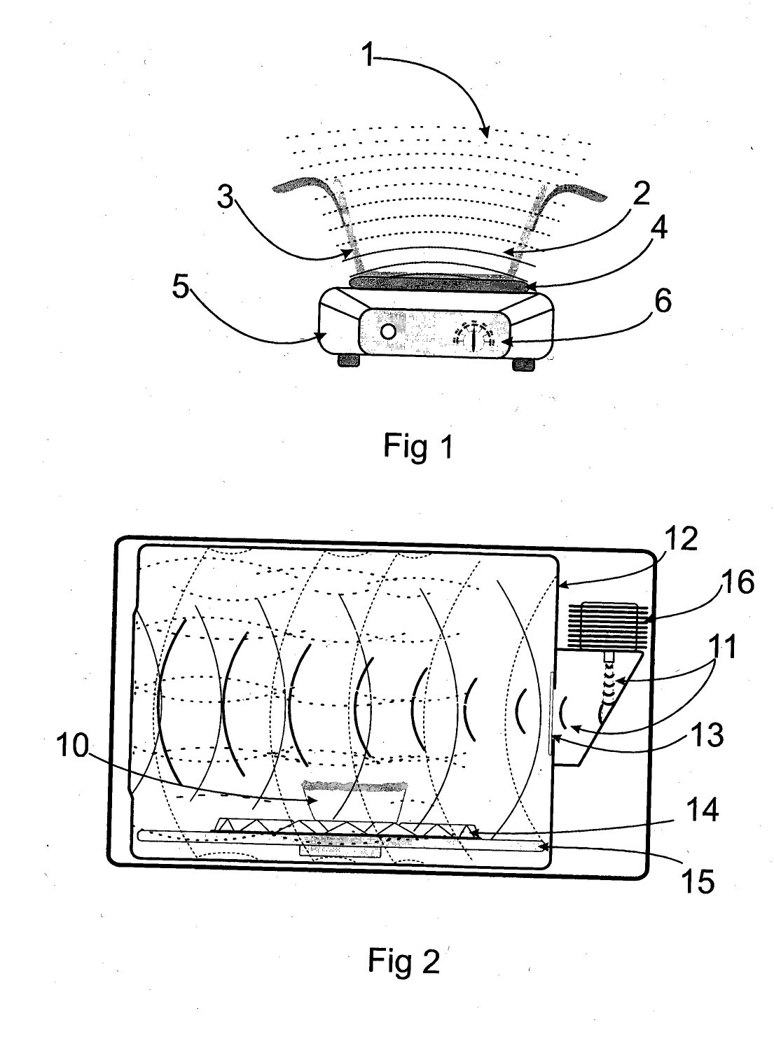

We have been using infrared heat to cook our food since day one with excellent results. This ancient method is slow (FIG. 1), inefficient and contaminating; the heat is applied by external Heat Source 4 and it's absorbed gradually by the Food 2. When used properly, this method preserves the original or desired texture, original quality and goodness.

Conventional cooking is a benign cooking method. Conventional appliances are simple to use, sets low power as default, allowing the user to master all appliances easily. Conventional appliances are alike and deliver more or less the same rate of heat (see Thermostat Control 6). The user quickly discovers if his/her appliance is fast or slow and from then on, knows exactly how to use his/her new appliance.

Cooking has become part of our nature. We have the need to “pre-digest” or cook a large part of our intake and over the years this has evolved in a sophisticated enjoyable process to obtain the nourishment required for a healthy living.

Boiling water evaporates and water evaporation produces low temperature and keeps the temperature of all ingredients below 100° C. at sea level and decreases as the altitude increase's. Without water the temperature rises, OVERHEATING in minutes carbonising all ingredients by radiation. Charred food becomes dark brown, bitter, unpalatable, comprising little or no nutritional value, and would not be suitable for continuous human consumption.

Conventional Cooking in FIG. 1 uses Infrared Heat 1 a long and slow wave; this source of energy slowly penetrates and heats solids by conduction, liquids and gases by convection and through anything by radiation. For the reason that heat is applied externally, thereby using a large amount of energy and a fraction will be absorbed by the Food 2 in Container 3. All conventional means will pollute food to a degree and some inevitably will be absorbed by the food for example, metallic cooking, ceramic paint and plastic coated appliances, while electrical Heat Source 4 releases contaminating fumes as they rust away.

How Microwave Produces Heat

The Good News

Government bodies' exercise a strict control of the electro-magnetic waves frequency dedicated to drive microwave ovens at a low frequency well within a scientifically known safe area for food in general; the frequency is 2450 MHz, a low frequency proven unable to alter foods composition or structure or detriment food in general in anyway. Therefore, current microwave ovens are absolutely non-contaminating, the best means capable to preserve foods original taste, texture, quality, goodness and requires 10% of the energy of conventional ovens if used properly.

The Bad News

But misguided market trends as “big or fast is better,” “instant food”, etc. without knowing microwaves capabilities, leads to designing powerful microwave ovens. Thus microwaves efficient infrared heat generation inside and around food have the capability to destroy food's delicate nutritional compounds as follows:

In FIG. 2 a Magnetron 16 produces Microwave Energy 11 which goes into a Metallic Box 12 or Microwave Oven's Cavity through a Microwave Output 13 to heat a Meat Pie 10 resting on top a Warming Tray 14 as follows; the Meat Pie 10 receptive elements absorb Microwave Energy 11 available mainly at the top and some on the side and virtually none at the bottom, from a chaotic distribution of bouncing microwaves within the microwave oven's cavity or Metallic Box 12.

The rotating Turning Table 16 is the only means to even out the Microwave Energy 11, therefore pops and splatters from fast heating hot spots so overheating are normal events. Obviously under these conditions foods, nutritional content is destroyed consistently with every pop and splatter. Nutrients destruction is exacerbated by the concentration of microwave receptive elements and food containing little water such as stews, pastries, tempuras, etc. Therefore low humidity foods easily overheat thereby ruining food's texture, quality and goodness, becoming unfit for human consumption.

Actually without water, receptive elements are capable to generate localised extreme temperatures in a fraction of a second and auto-incinerate. Therefore nutrients become a lifeless, abrasive ash, while non-receptive elements are carbonised by radiation. The food is now abrasive, it may look edible, a bit pale, some dark spots, perhaps chewy, dry, tasteless or hard as a rock, harmful in the long run. Such food will grind-off our internal linings as it passes through our mouth, oesophagus, stomach digestive organs and providing little or no nutritional value.

Microwave Receptive Elements

Microwaves heat only receptive elements; from the perimeter inward, containers do not have receptive elements thus cannot absorb energy therefore will remain cold, feeding a popular myth “microwaves heat inside out”. The container eventually will get hot by irradiation. Another myth is that “microwave and conventional means are different”; this research core finding has proven beyond doubt, the same infrared heat is generated in different ways but conventional means and microwave ovens both uses infrared energy to heat and cook.

### Ingredients Electrically Bipolar

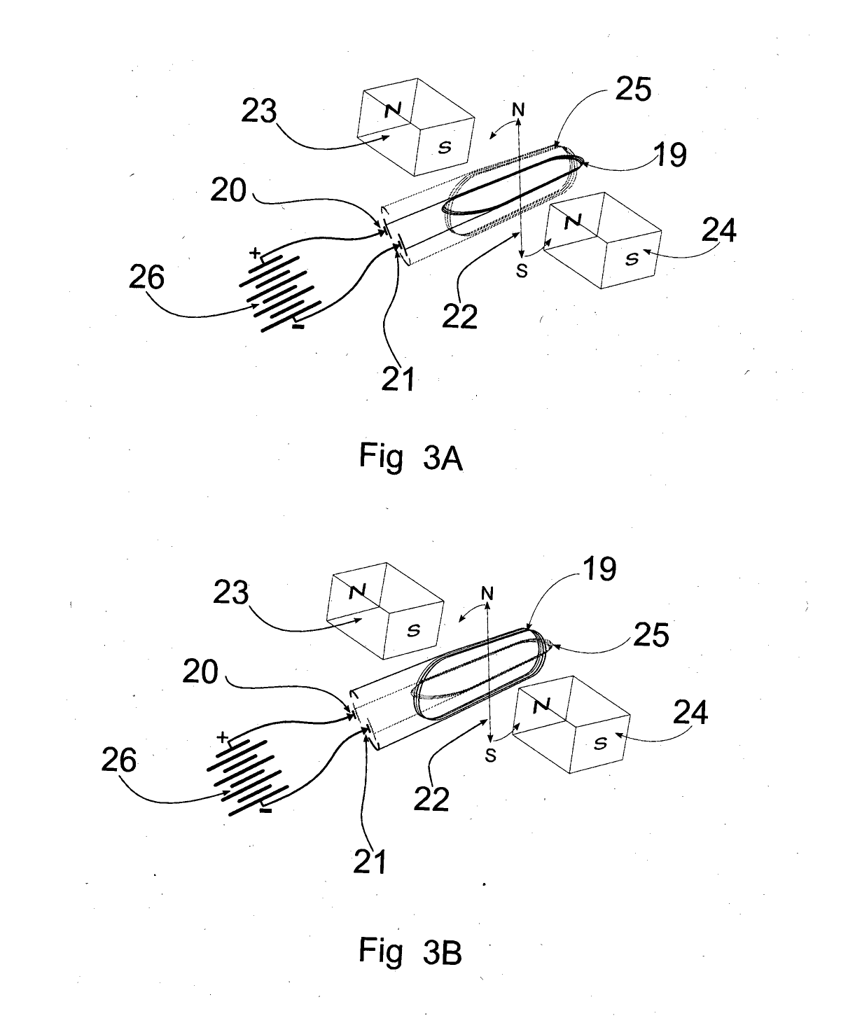

Molecules of water, oil, fat, lard, cream and similar are Bipolar Molecules meaning they have a positive charge at one end and a negative charge at the other. Bipolar molecules are not restrained so they can move freely therefore under an electromagnetic field as expected they have a tendency to rotate while trying to align or follow the continuously changing electromagnetic field of 2450 million changes in polarity per second. This is the same natural phenomenon that allows electrical motors to turn; actually the water molecules behave in a way as “Molecular Electric Motor” outlined in FIGS. 3A and 3B. The Electric Motor basic principle is as follows.

In FIG. 3A the Black Coil 19 is energised from the Battery 26 through the corresponding ±Brushes 20-21 creating an Electro-Magnetic Field 22, top “N” north will travel to the Permanent Magnet S 23 south and bottom “S” south toward the Permanent Magnet N 24 north, but half way the Black coil 19 become disconnected and the Grey Coil 25 becomes energised as shown in FIG. 3B and the same sequence starts again so North keeps chasing South and South keeps on chasing North therefore millions or billions of molecular electrical motors furiously keep on turning within the microwave electromagnetic energy flux.

This vigorous movement creates a chaotic molecular movement which hits and sets off all other receptive elements against each other and against static non-receptive molecules producing friction and friction produces heat, ie. pure and simple infrared heat as from a regular conventional appliance, around and inside the food.

The integrity of the foodstuff under the Microwave Energy or Electromagnetic field is 100% assured the only outcome from this violent movement is infrared heat; the only real risk is OVERHEATING.

Ingredients Electrical Conductive

Some of our nutrients are “Electrical Conductive Molecules” as mineral traces, vitamins, salt, etc. which generates heat under continuously changing electromagnetic fields by reacting as a miniature or “Molecular Aerial” absorbing energy of this large electromagnetic energy available as a regular radio receiver and extreme violently releases instant heat as follows.

Aerial Receiver Effect

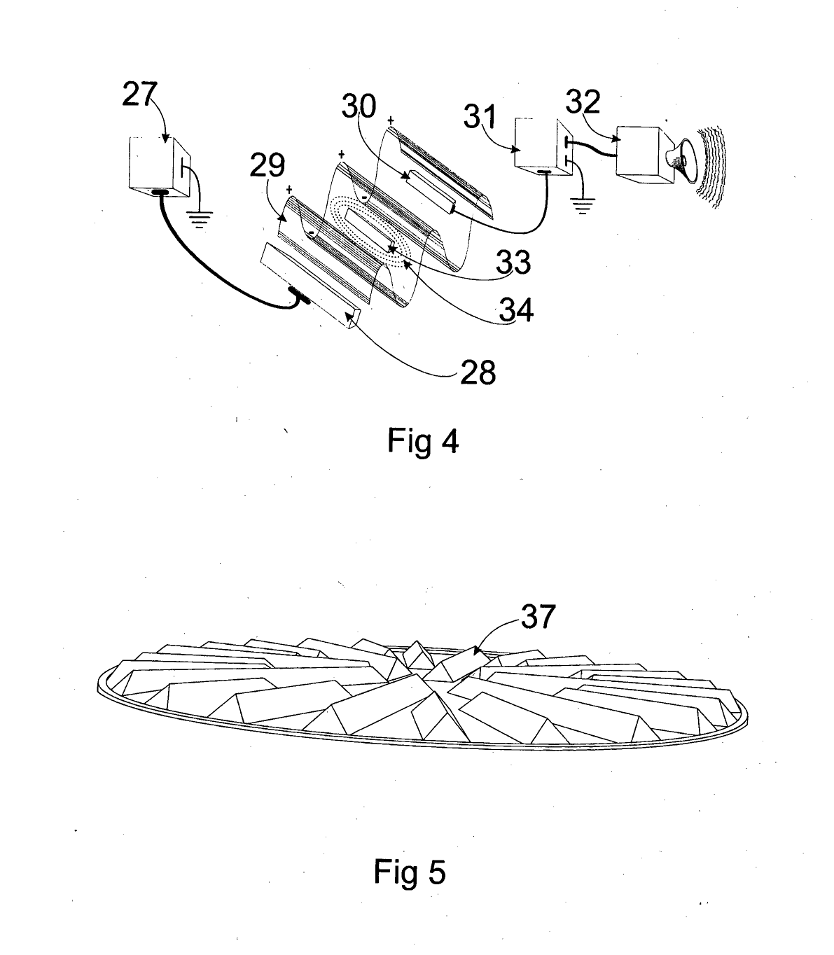

Wireless Communications are possible using Electro-Magnetic Waves 29 as shown in FIG. 4. The Transmitter 27 irradiates through the Transmitter Aerial 28 a predetermined Electro-Magnetic Wave 29 say embedded with “our” music, the Receiver Aerial 30 an efficient electrical conductive medium absorbs electromagnetic energy which in this case is very-very little energy; the Receiver 31 detects all signal available in the ether and isolates the signal with “our” music, for example, which is released to the Amplifier 32 which in turn makes “our” music loud enough to be audible.

Microwave ovens are enclosed Metallic Boxes and the food is at a short distance; the energy available in microwave ovens is massive. Electrical conductive elements around and inside the food will absorb the high energy and release Infrared Heat 34 virtually no loss, pure infrared heat 2450 Million burst per second from millions or billions miniature or Molecular Electrical Heating Element 33 around and inside the food. This is the reason for using low power for foods with low humidity and high concentration of electrical conductive ingredients.

Another technology for reheating pastries in microwaves involves Susceptors which basically are papers with a semi-conductive surface capable to transform microwave energy into infrared heat but microwaves inside the oven. The chaotic distribution of microwave energy produces hot spots thereby burning the susceptors surface or may go up in flames. Hence, susceptors have been banned in Australia because of this fire hazard.

Ingredients Heat Generation Classification

The amount of heat generated by food's receptive ingredients under microwave energy can be used to group the receptive ingredients. This will help to assess the method, heat setting and time required for a particular meal. The receptive elements may be classified as follows: (a) Low Heating Element, (b) Fast Heating Elements and (c) Instantaneous Heating Elements.

(a) Low Heating Elements

Pure, Distilled or Demineralised Water molecules despite the fact that are bipolar cannot conduct electricity; actually pure water insulates electricity, while electrical conductive elements (eg., salt, mineral traces, etc) allow water to conduct electricity. Therefore water is the lowest heating element under microwave energy; but absorbs and conducts heat efficiently; water reacts violently under microwave energy, generates heat fast, boils, and evaporates keeping the temperature to 100° C. at sea level. The recommended healthy setting for Low Heating Element is Medium to Low for a relatively short time.

(b) Fast Heating Elements

Bipolar molecules lighter than water as oils, fats, cream, etc. under microwave energy react from violent to extremely violent. The heat generated ranges from fast to extremely fast as their concentration increases. To avoid their destruction, the energy applied and exposure time must decrease proportionally as the concentration of fast heating elements increases. The healthy setting for Fast Heating Elements is Medium/Low to Low for a short time.

(c) Instantaneous Heating Elements

Electrical conductive molecules under microwave energy to some extent explode instantly. The heat generated ranges from extremely fast to instantaneous to avoid their destruction as the concentration of instantaneous heating elements increases the energy applied must be decreased exponentially. The healthy setting for instantaneous heating elements is Low for a short time.

Microwave Ovens Capability

This aspect is important from the energy transfer point of view. The present inventor's research results have established that microwave and conventional appliances both employ infrared heat to cook, therefore both have the capability to deliver the same result like crisping, boiling, steaming, simmering, browning and baking as long as the energy is applied at the same rate, intensity and time as required for that particular type of food and the desired outcome.

Microwave Ovens Heat Distribution

Microwaves Achilles' tendon is the science and apparent complexity behind microwave generation, distribution, absorption and heat generation which in microwave ovens are a sequence of challenging technical issues. The electrical energy is transformed by a single Magnetron, a device capable to compact electromagnetic energy into a microwave energy beam. This beam is directed to metallic surfaces in which the energy beam bounces and expands as microwave energy toward the oven's cavity, passing through the Microwave Ovens Output 13 shown in FIG. 2, normally a heat resistant and non-electrical conductive lid. The microwave output sits about 20 mm to 30 mm above a bidirectional turning table. The microwave energy will hit the food and receptive elements heat the pie's exposed surfaces and travels inward, thereby heating receptive elements and thus transferring the energy around and into the food efficiently.

The turning dish is the most popular way to even the heat distribution and minimise cold and hot spots, but cold and hot spot remains a common problem of all microwave ovens.

The best recommendation at the moment is to stop the process, stir the food to even out the temperature; if this is not possible, to rest the food for a while before serving.

In a Conventional-and-Microwave Ovens Combo, the microwave output is located hard to the top, “out of the way” to allow the usage of metallic grillers, making these ovens the most inefficient microwave oven available.

Microwave Ovens Health Hazard

The present inventor's research clearly calls to redesign microwave ovens to remove current perceptions related to health issues, and to provide a better means of microwave cooking.

Current microwave ovens process safely foods saturated with water, are excellent to steam, boil and reheat water saturated foods; actually they look as an oven but really work as cooking pots but for foodstuff with low humidity content use only Low Setting.

Warning

If food pops and splatters during microwave cooking or heating, the power setting is too high and the food is overheating thereby obliterating food's quality and goodness. Thus, immediately lower power setting and may need to adjust the cooking time.

Microwave Ovens Size and Power

Conventional Ovens in general all work more or less by the same practice by simply setting the temperature and time. Unfortunately the absence of temperature control in microwave ovens means that the cooking parameters are time and power output. Microwave ovens output and the physical size are not standardized. Also, there are no standards related to microwave ovens cooking capabilities, and physical sizes are misleading at best due to large difference in power. Some microwave ovens are small in size and big in power or vice versa and on top of that there are two types of microwave ovens “On-Off” and “Inverter”.

The only common feature to all microwaves is the power output in watts which is not easy to find out for the reason that microwaves are retailed normally by the size of the oven's cavity in litres which is not closely related to the energy available. For example, a physically large oven with a relatively low power or watts output is not uncommon. Normally microwave ovens from 500 Watts to 700 Watts are small and from 800 Watts to 1.200 Watts are larger, or more or less the same size.

Another dilemma is that an old 700 Watts microwave oven at full power, for example, has more or less the same heating capability as a large new 1200 Watts device at Medium, making it almost impossible to develop recipes for all microwaves. Therefore the easy way out is to develop all recipes for 1000 Watts microwave ovens at FULL POWER, making it difficult to cook healthy food in microwave ovens or produce recipes for microwave ovens in general. Currently the consumer is supposed to learn without knowing the nature of the beast, ie., the user is supposed to learn how to use his/her particular, microwave oven by trial and error.

Microwave Oven Types

(a) Microwave Ovens On/Off

These microwave ovens are cheap and nasty designs without temperature control. One cheap way to control the temperature indirectly is by setting on/off period of full power on and no power, but without standards. On/off periods vary between old/new, power output, physical size and manufacturer of microwave ovens. At Full setting the magnetron is always on, after that on time decreases and off time increases.

(b) Microwave Ovens Inverter

Despite the absence of temperature control Inverter technology is a step in the right direction. The heat generated is controlled by changing the power output from default high about 1100 Watts full output down to about 100 Watts at the low end. This continuous heat generation to some extent resembles conventional means but with a sizeable difference in how infrared heat is transferred to the food, using conventional means, ie., only a fraction of the heat is absorbed and microwave energy generates heat around and inside the subject with negligible losses and efficient heat transfer.

Microwave Ovens Bad Reputation

The present inventor has been studying and researching microwave for over 20 years and has found that microwave appliances have earned a bad reputation from different fronts such as:
Misinformation from professional chefs and cooking personalities with little or no understanding of microwave technology.
The frozen food industry's fixation with fast food and their ill conceived recommendation of high power microwave ovens to cook or re-heat food faster.
Almost all microwave recipes ask for high power setting which is the only consistent instruction possible due to the absence of microwave standard regarding setting denomination, appliances physical and power sizes.
Marketing perceptions like, large families need a large and powerful microwave oven.
Popular understanding that big is better.
Microwave designing engineers with no cooking expertise and apparently no idea regarding the amount energy required to cook.
Domestic microwaves output used to be from 500 to 1,000 watts, now range from 800 to 1,200 watts. If a conventional ovens ranges from 2,000 to 4,000 watts and microwaves requires only 10% of conventional output to provide the same outcome, then microwaves ovens use 1/10th of conventional means energy say 200 to 400 watts thus microwaves are awful big 4 times at the low end and 3 times the upper end.
Microwave physical sizes are misleading is possible to find some small in size and big in power or vice versa.
Cheap and nasty designs driven by cost without temperature control, this is the biggest disadvantage against conventional ovens.
The worst feature, microwave ovens are the only cooking appliances with high power as default.
Need for microwave that lowers the power setting, adjust the time and hit start. In practice, users set the time and hit start, default is the most popular setting thus the probability to spoil food increases dramatically.
These days, each household has at least one microwave oven; a modern kitchen looks incomplete without it. Although, microwave ovens are a must have kitchen appliance, some users are apprehensive about its use and some do not know how to use them properly, resulting in improper or little use of this appliance.

Unfortunately, most microwaves are relegated just to re-heat the odd thing and are often the last choice in cooking appliances. The best cooking appliance available is actually a waste and sits idle rusting away.

The previous devices keep pastries' bottom dry in microwave ovens but once sogginess was beaten, a huge hidden problem of microwave ovens, overheating remains. For example, pastries reheated at full power at best finish up piping hot or ruined either chewy or hard as rock therefore the research took a different direction; now the task was to preserve the original taste, texture, quality and goodness. The research expanded to all foods, new methods and corresponding new devices.

The present invention, FIRST WAVE is for all foods and when used properly, preserves food's original or intended quality, texture, original nutritional value and good taste.

After a methodical and extensive research the present invention provides a novel method to use current microwave ovens preserving consistently the original texture and goodness, resulting in healthy microwave frozen food, redesigning current microwave ovens making these a food-friendly device, and introducing a new, generation of industrial, domestic microwave ovens capable to cook, steam, bake and brown faster and more efficient than conventional means using under 95% of energy and under 50% of current microwave ovens energy.

### Original Domestic Application

The Warming Tray 37 in FIG. 5 is a solid plastic tray designed to re-heat pastries and solid food on demand.

### Original Commercial Application—Microwave Pastries

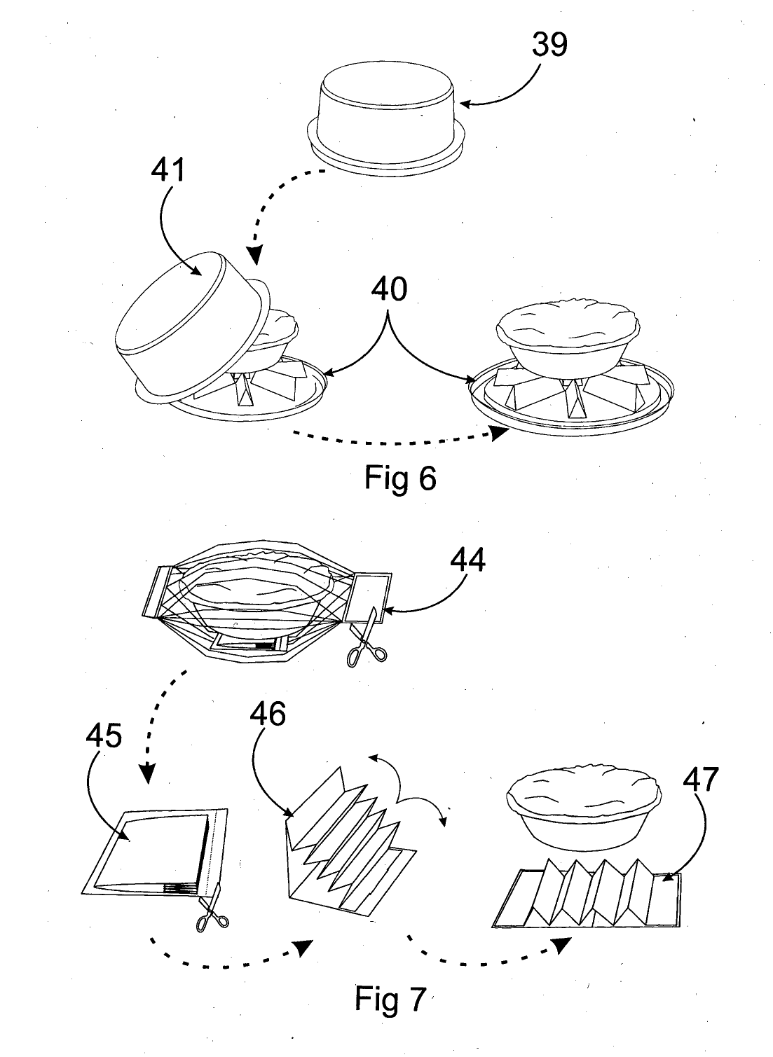

The Packing-heating Device 39 in FIG. 6 comprises: a light plastic packing, a Warming Tray Base 40 and a Lid 41 to retail and heat pasties in microwave ovens once, replacing the current commercial packaging.

Heating Inserts in FIG. 7 are low cost Paper Inserts in this Flexible Packaging 44 comprised by a Hygienically Sealed deployable Meat Pie Insert 45, shown Half Open Insert 46 and Fully Open Insert 47 to retail and heat pastries in microwaves once and uses the current commercial packaging.

These original devices eliminate sogginess but are powerless against overheating, actually exacerbated the problem by reducing the humidity. Therefore for the earlier inventions to work consistently and preserve the original quality and goodness, overheating must be controlled. Therefore latest innovation First Wave is added to the original devices as follows.

First Wave Method

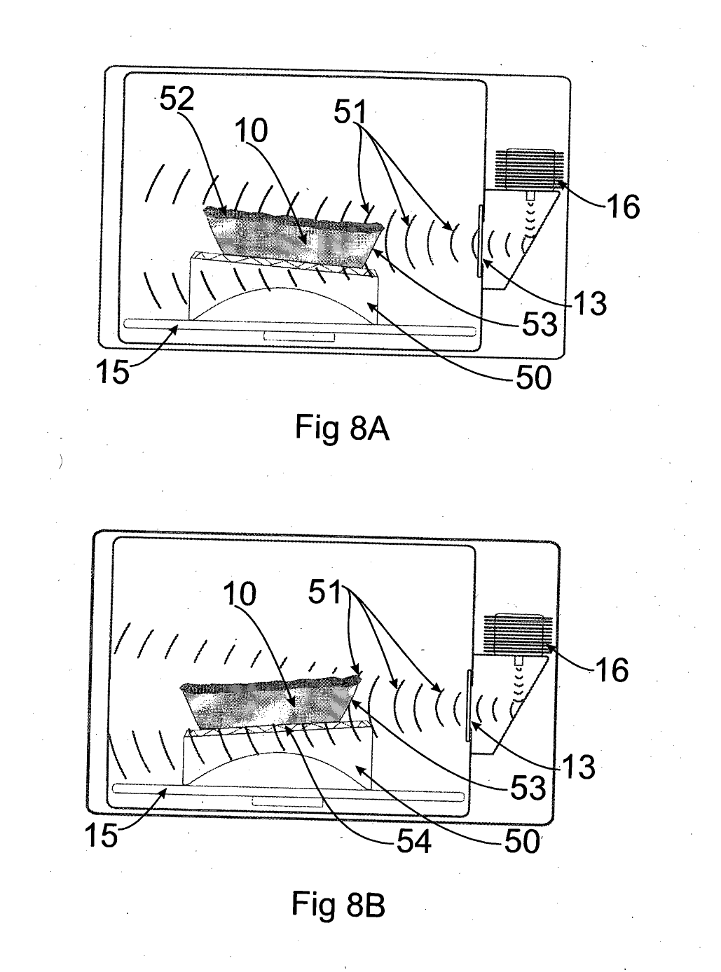

The solution to OVERHEATING and the recipe to produce healthy foods with current microwave ovens may adapt the particular configuration as shown in FIGS. 8A and 8B. The Micro Frame 50 supports and lifts a Meat Pie 10 to face the Microwave Output 13 and heats up the Meat Pie 10 gently like in conventional ovens by exposing a Meat Pie 10 completely to a FIRST WAVE as illustrated by the Waves 51 which are wide enough to heat the food evenly as in FIGS. 8A and 8B as follows:
In FIG. 8A the Meat Pie Top 52 and half of the Meat Pie Side 53 gently heats up during the Turning Table 15 first half turn, like in a conventional oven.
In FIG. 8B the Meat Pie Bottom 54 and the rest of the Meat Pie Side 53 heats up during the Turning Table 15 completion of a turn like in a conventional oven.

The research tests indicate that on first wave with an “On-Off” driven microwave oven of 1000 watts at “Low Setting” uses about 43% and “Inverter” driven microwave ovens of 1100 Watts between settings 4 and 3 uses about 330 to 440 Watts or 30% to 40% depending in the amount of Fast and Instantaneous Heating Elements. Surprisingly, reheating or cooking time is not as long as recommended by frozen food manufacturers for current microwave ovens at full power. Hence, the food being aligned to the microwave output absorbs considerably more microwave energy or electro-magnetic energy, thereby increasing microwave ovens' efficiency. Therefore this system uses under 50% the energy of current microwave ovens and under 5% the energy of conventional means.

Hot Water Splattering

Sometimes food items such as water or liquids are heated in microwave ovens and later the surface is disturbed by immersing a tea bag, coffee, or adding sugar or just by shaking the liquid, resulting in the food item to violently explode and splatter, causing sometimes severe burns for the following reasons:
Microwave ovens' microwave outlets are located too high
The rotating table turns smoothly and slow, keeps water or liquid steady
The upper end is overheated and the bottom remains cold
If surface is disturbed and the surface tension is broken between hot and colds areas
Hot and cold areas mix abruptly
Therefore piping hot water meets cold water
Exploding violently and far too often may burn the user.

This is another reason to tilt the frame as much as possible, to disturb the liquid and unsettle the water consistently heating the water unevenly and by continuously mixing hot and cold water.

Improvements to the design may include addition of shallow bumps, producing a continuous significant disturbance across the liquid.

The Warming Tray has a winning chance against overheating but the tray must be raised without increasing the overall height and to keep packaging and transport competitive.

Warming Tray and Micro Frame Embodiments

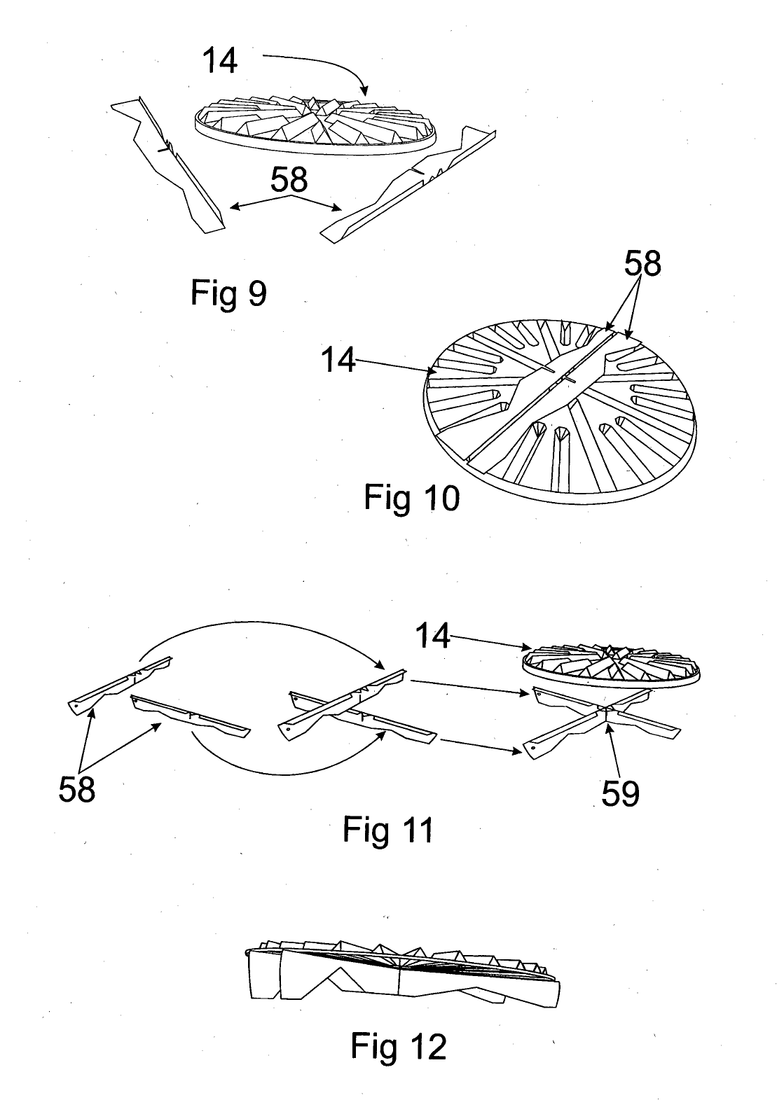

One way to transport the Warming Tray 14 keeping a low profile is with a set of two Brackets 58 as shown in FIG. 9, designed to fit on the back of the Warming Tray 14 as shown in FIG. 10. FIG. 11 is shown in a sequence of figures; the user first removes the Bracket 58 and then locks both Brackets 58 by forming a Cross 59 which will support the Warming Tray 14 and food as required by the First Wave Method.

Frozen Food for Microwave Ovens

It takes more energy to reheat frozen food by one or two portions in inefficient domestic ovens than by large quantities in efficient industrial ovens, First Wave has the capacity to make the frozen food industry carbon negative.

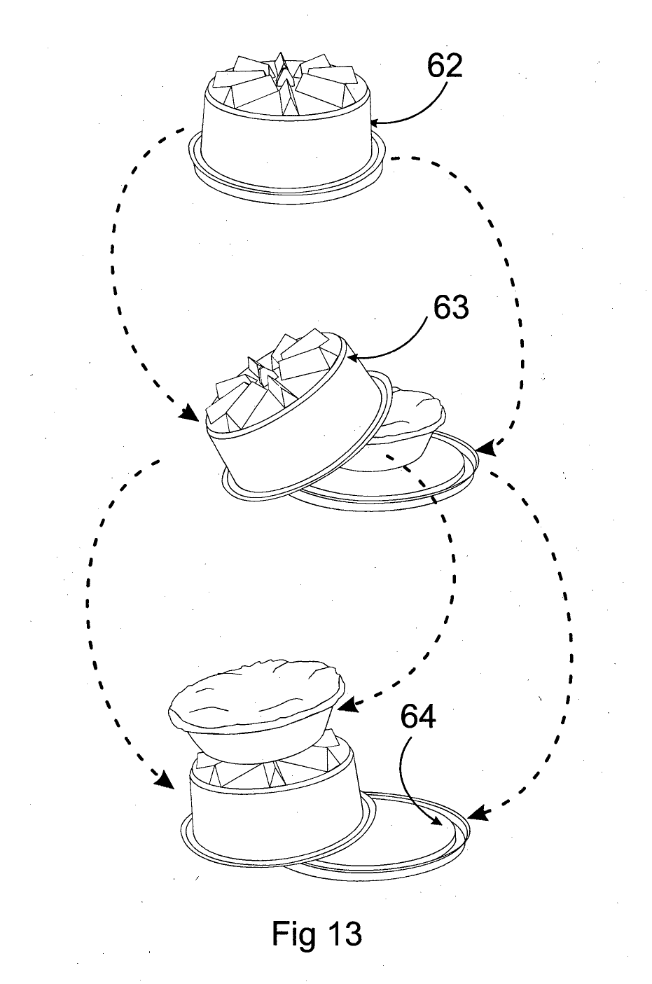

Packing-Heating Device 39 in FIG. 6 and inserts shown in FIG. 7 may be risen and tilted to take advantage of the First Wave Method in current microwave ovens as shown in the sequence of FIG. 13. A Meat Pie 10 or any solid food can be retailed in a Packing-Heating Container 62, a Warming Tray Lid 63 and the Packing-Heating Base 64 to tilt the Meat Pie 10 or the lid can be designed tilted.

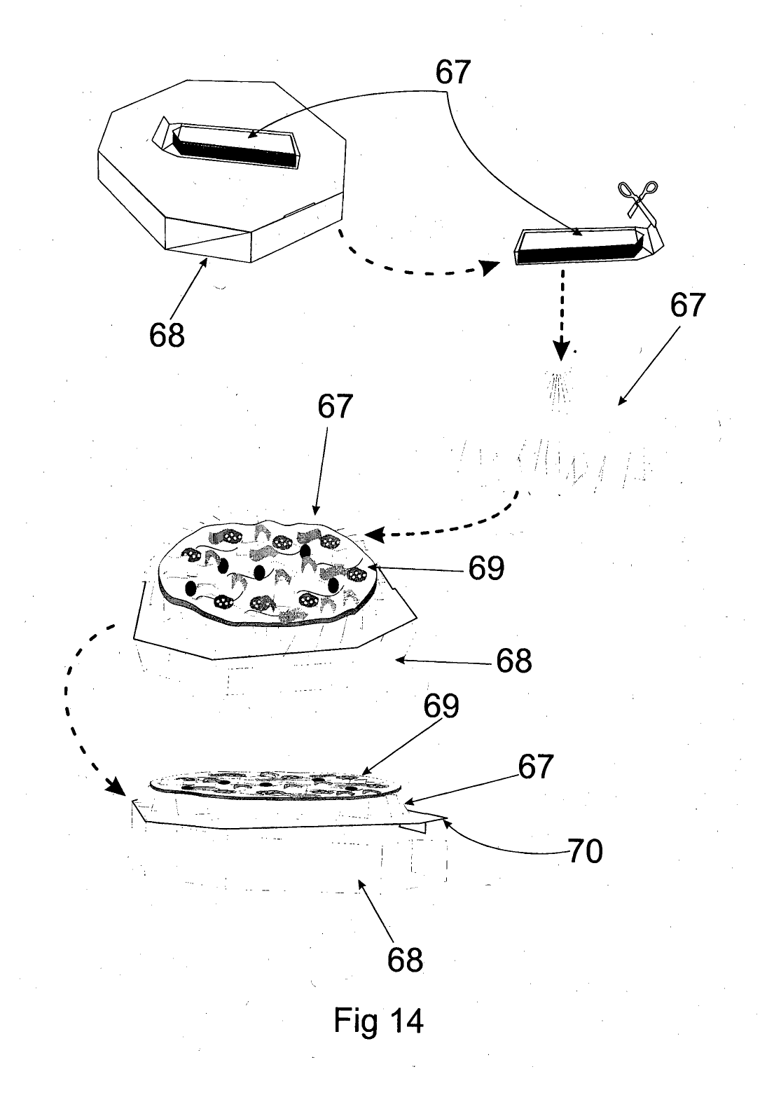

Insert devices can use the packaging as a lifting means as shown in the sequence of FIG. 14. A hygienically sealed Pizza Insert 67 sits on top of a hexagonal Pizza Box 68, for, example. The Pizza Insert 67 is open, deployed on top of the Pizza Box 68 and the Frozen Pizza 69 is placed on top. The following view highlights the Pizza Box Lid 70 is open to tilt the Frozen Pizza 69 satisfying the First Wave method. Paper inserts can be designed tilted so that the Lid 70 may remain closed and be more stable.

### Food-Friendly Microwave Ovens

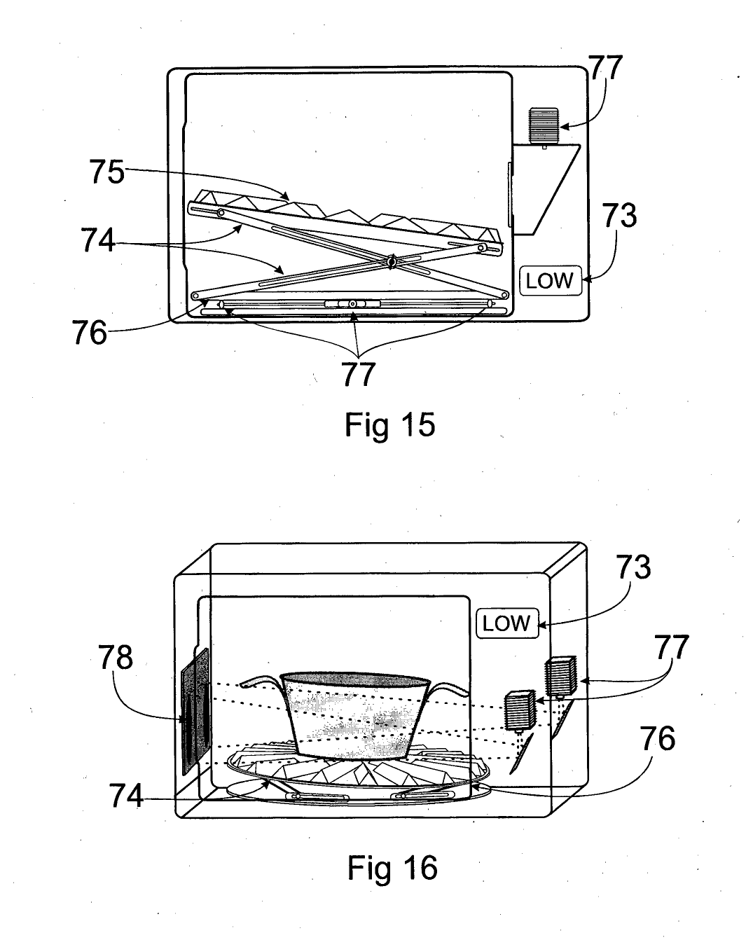

Current microwave ovens with some minor modifications can become “Food Friendly” as shown in FIG. 15.
Low Setting 73 as default
Align and tilt the turning table with microwave energy outlet, or better still add Adjustable Means 74 and a Fixed Warming Tray 75.
The liquid surface tension can be disturbed by adding a small imperfections to the Turning Table 76 Support Wheels 77
Reduce Magnetron 78 output to below 500 watts

### Multi-Magnetron Microwave Ovens

Microwave energy is extremely efficient; energy is beamed directly to the substance being heated, virtually no energy loss due to its capability of producing “INFRARED HEAT AROUND AND INSIDE” the product or food.

Currently the energy of domestic microwave appliances is applied by one large magnetron up to 1200 watts, so food overheating is common event. One way to reduce microwave overheating and maintain or increase cooking speed within healthy parameters is feasible by using more than one low power magnetron. MULTI-MAGNETRONS maintain or increase microwaves' heating capacity but the food is still exposed to a single low power magnetron facilitating a heat source closer to the environment of conventional ovens.

Microwaves transport electro-magnetic energy and they have the peculiar ability to “add” the energy when are synchronised in the same direction or “cancel” when are synchronised in the opposite direction and any result in between. If microwave energy is beamed into a metallic box it will bounce uncontrolled creating hot and cold spot.

Multi-magnetrons will generate a smoother and even microwave energy if:
Magnetrons output are synchronised by connecting them in parallel from a single high voltage transformer.
Keep each beam separated to minimise the creation of hot spot.
Absorb bouncing microwaves likely to produce hot spot or overheating spot with a “Semi-Metallised Plate” which will absorb microwave energy and release heat.
The Magnetron Cooling Fan present in all microwaves ovens may also distribute the heat generated by the semi-metallised plate.

On-Off microwaves technology is not suitable for multi-magnetron microwave ovens. Multi-magnetron requires full control of the microwave energy beam as in INVERTER TECHNOLOGY. This combination makes possible a new generation of microwave driven appliances to process foods and for industrial, scientific or medical applications, thus increasing the probability to preserve the original taste, quality, texture and goodness.

Microwave by nature is the most efficient technology to evaporate water thus is the most efficient method to cook and dry corn chips, potato chips, biscuits and alike; cooking and drying represent over 30% of the manufacturing cost plus the reduction in CO₂ emissions.

The warming tray, food friendly microwave ovens and multi-magnetron technology open the door of microwave driven industrial dryers to process corn chips, potato chips and biscuits. These machines will reduce significantly the current manufacturing energy costs by replacing oil, gas and electrically driven industrial dryers.

FIG. 16 illustrates the basic multi-magnetron Microwave Oven
Low Setting 73 as a default
Adjustable Means 74 and a Fixed Warming Tray 75.
Irregular rotation to the Turning Table 76
Semi-Metallised Plate 78 large enough to absorb microwave energy and release infrared heat
Reduce both Magnetrons 77 output below 500 watts.

### Carbon Trade Basic Criteria

First Wave technology provides devices and method designed to save energy and help the households, Frozen Food Industry, Catering Industry, Corn/Potato Chip Industry, Biscuit Industry, Commercial Food Preparation and related industries closer to become hopefully “Carbon Negative”, reducing the energy requirement by at least 95%.

The snap shot below shows one of the products in the Australian market as an example of energy savings and reduction in carbon emission by utilising a microwave oven compared to a conventional oven.

Australians consume 260 Million meat pies a year. Table 1 below compares energy consumption and other factors between conventional and microwave appliances, if 10% of pies are reheated in Microwave ovens.

TABLE 1
There are 10 millions of househol ds In Australia with microwave ovens.
IF 10% uses First Wave Microwaves Oven instead a Conventional Oven ONCE

| ONE PIE IN A FOOD FRIENLY MICROWAVE OVEN | | | ONE PIE IN A FOOD FRIENLY MICROWAVE OVEN | | |
|---|---|---|---|---|---|
| 1 Pre-heat oven | 20.00 | minutes | 1 Pre-heat oven | 0.00 | minutes |
| 2 Pie cooking | 10.00 | minutes | 2 Pie cooking | 4.00 | minutes |
| 3 Total cooking Time | 30.00 | minutes | 3 Total cooking Time | 4.00 | minutes |
| 4 Convential Ovens 3 to 5 Kw | 4,000.00 | watts | 4 Maxium Energy required for pastries | 400.00 | watts |
| 5 Energy in watt/minutes | 120,000.00 | watts/minutes | 5 Energy in watt/minutes | 1,600.00 | watts/minutes |
| 6 Energy in watt/hour | 2,000.00 | watts/hours | 6 Energy in watts/hours | 26.67 | watts/hours |
| 7 1 million users usage watt/hour | 120,000,000,000.00 | watts/hours | 7 1 million users usage | 26,666,666.67 | watts/hours |
| 7 1 million users usage | 120,000,000.00 | Kwatts/hours | 7 1 million users usage | 26,666.67 | Kwatts/hours |
| 8 1 Kwatt/ hour cost in Australian $ | 0.24 | AU$ | 8 1 Kwatt/hour cost in AU$ | 0.24 | AU$ |
| 9 Total Energy cost in AU$ | 28,464,000.00 | AU$ | 9 Total Energy cost | 6,325.33 | AU$ |
| Energy saving in Kilowatts | 119,973,333.33 | | Saving in Australian Dollars | 28,457,674.67 | |

1 Million Pies in a First Wave Microwave Ovens will save about 894 Ton of CO₂
1 Kilowatts = 0.6 kg of CO₂

While considerable emphasis has been placed herein on the specific features of the preferred embodiment, it will be appreciated that many additional features can be added and that many changes can be made in the preferred embodiment without departing from the principles of the disclosure. These and other changes in the preferred embodiment of the disclosure will be apparent to those skilled in the art from the disclosure herein, whereby it is to be distinctly understood that the foregoing descriptive matter is to be interpreted merely as illustrative of the disclosure and not as a limitation.

Drawings Components Numbers

| | |
|---|---|
| 1 | Infrared Heat |
| 2 | Food Fat |
| 3 | Container |
| 4 | Heat Source |
| 10 | Meat Pie |
| 11 | Microwave Energy |
| 12 | Metallic Box - Cavity |
| 13 | Microwave Output |
| 14 | Warming Tray |
| 15 | Turning Table |
| 16 | Magnetron |
| 19 | Black Coil |
| 20 | +Brush |
| 21 | −Brush |
| 22 | Electromagnetic Field |
| 23 | Permanent Magnet S |
| 24 | Permanent Magnet N |
| 25 | Grey Coil |
| 26 | Battery |
| 27 | Transmitter |
| 28 | Transmitter Aerial |
| 29 | Electromagnetic Wave |
| 30 | Aerial Receiver |
| 31 | Receiver |
| 32 | Amplifier |
| 33 | Electrical Conductive Molecule |
| 34 | Infrared Heat |
| 37 | Warming Tray |
| 39 | Packing Heating Device |
| 40 | Warming Tray Base |
| 41 | Lid |
| 44 | Flexible Packaging |
| 45 | Meat Pie Insert |
| 46 | Half Open Insert |
| 47 | Fully Open Insert |
| 50 | Micro Frame |
| 51 | Waves |
| 52 | Meat Pie Top |
| 53 | Meat Pie Side |
| 54 | Meat Pie Bottom |
| 58 | Bracket |
| 59 | Cross |
| 62 | Packing-Heating Container |
| 63 | Warming Tray Lid |
| 64 | Packaging Heating Base |
| 67 | Pizza Insert |
| 68 | Pizza Box |
| 69 | Frozen Pizza |
| 70 | Pizza Box Lid |
| 73 | Low Setting |
| 74 | Adjustable Means |
| 75 | Fixed Warming Tray |
| 76 | Support Wheels |
| 77 | Magnetron under 500 Watts |
| 80 | Semi-Metallised Plate |

1-20. (canceled)

21. A microwave oven, comprising:
a magnetron operable to produce microwave energy;
a food compartment sized and shaped to receive a food item, the food compartment defining a microwave output port positioned to allow the microwave energy from the magnetron to flow to the food compartment; and
a tilted surface within the food compartment, the tilted surface operable to tilt the food item towards the microwave output port and to raise the food item to a height of the microwave output port to cause the microwave energy to be absorbed by the item prior to being dispersed by the interior of the microwave oven.

22. The microwave oven of claim 21, wherein:
a tilt and height of the tilted surface cause a first wave of the microwave energy to be absorbed by the food item.

23. The microwave oven of claim 21, further comprising:
a second magnetron operable to produce microwave energy, the second magnetron directed at the microwave output port to direct the microwave energy at the food item.

24. The microwave oven of claim 21, wherein the tilted surface comprises:
a warming tray with two detachable brackets operable to be fitted to an underside of the warming tray, the two detachable brackets operable to position the warming tray in a tilted configuration.

25. The microwave oven of claim 21, wherein:
a default power setting for the microwave oven comprises a low power setting.

26. The microwave oven of claim 21, wherein:
the magnetron has a power of less than 500 watts.

27. The microwave oven of claim 21, wherein the food compartment comprises:
a semiconductive wall disposed opposite the microwave output port and operable to release infrared radiation in response to receiving the microwave energy.

28. The microwave oven of claim 21, wherein:
when the microwave oven is in operation, the tilted surface is operable to rotate on support wheels having small imperfections that disturb the food item.

29. The microwave oven of claim 21, wherein:
the tilted surface is included within a food packaging associated with the food item.

30. The microwave oven of claim 21, wherein:
in operation, when rotated at a first angle, a top and side of the food item are heated by a first wave of the microwave energy, and, when rotated at an opposite angle, a bottom and side of the food item are heated by the first wave of the microwave energy.

31. The microwave oven of claim 30, wherein:
in operation, the food item is heated as in a conventional oven, due to the top and side being heated by the first wave when rotated at the first angle and the bottom and side being heated by the first wave when rotated at the second angle.

33. A method of heating an item, comprising:
placing the item on a tilted surface within a microwave oven; and
activating the microwave oven to direct microwave energy towards the item,
wherein the tiled surface is operable to tilt the item towards an opening within an interior of the microwave oven through which the microwave energy flows and to raise the food item to a height of the opening, to cause the microwave energy to be absorbed by the item prior to being dispersed by the interior of the microwave oven.

31. The method of claim 30, wherein:
a tilt and height of the tilted surface cause a first wave of the microwave energy to be absorbed by the food item.

32. The method of claim 30, wherein activating the microwave oven comprises:
activating a single magnetron to flow microwave energy towards the item.

33. The method of claim 30, wherein activating the microwave oven comprises:
activating more than one magnetron to flow microwave energy towards the item.

34. The method of claim 30, wherein placing the item on the tilted surface comprises:
placing the item on a warming tray with two detachable brackets operable to be fitted to an underside of the warming tray, the two detachable brackets operable to position the warming tray in a tilted configuration.

35. A food item packaging, comprising:
a tilted surface configured to be placed into a food compartment of a microwave oven,
wherein the tilted surface is operable to tilt the food item towards a microwave output port of the food compartment of the microwave oven and to raise the food item to a height of the microwave output port to cause microwave energy to be absorbed by the item prior to being dispersed by an interior of the microwave oven.

36. The food item packaging of claim 35, wherein:
a tilt and height of the tilted surface cause a first wave of the microwave energy to be absorbed by the food item.

37. The food item packaging of claim 35, wherein the tilted surface comprises:
a warming tray with two detachable brackets operable to be fitted to an underside of the warming tray, the two detachable brackets operable to position the warming tray in a tilted configuration.

38. The food item packaging of claim 35, wherein:
when the microwave oven is in operation, the tilted surface is operable to rotate on support wheels having small imperfections that disturb the food item.

39. The food item packaging of claim 38, further comprising the support wheels.

40. The food item packaging of claim 35, wherein:
the tilted surface comprises an extendable frame.
